(19) United States
(12) Patent Application Publication
(10) Pub. No.: US 2006/0217135 A1
(43) Pub. Date: Sep. 28, 2006

(54) Multimedia products and services marketing and sales method and methods of conducting business

(76) Inventors: Jeffery Moore, Seattle, WA (US); Ian Eisenberg, Seattle, WA (US)

Correspondence Address: John P. Luther;Newman & Newman LLP, Suite 610, 505 Fifth Avenue South, Seattle, WA, 98104, US

(21) Appl. No.: 11/089,842

(22) Filed: Mar. 25, 2005

(51) Int. Cl. H04Q 7/20

(52) U.S. Cl. 455/466; 455/412.1

(57) ABSTRACT

The present invention provides a method, product and system for correlating advertising efficacy with multimedia methods of marketing, offering for sale, selling and distributing products and services.

### FIELD OF THE INVENTION

The present invention relates to multimedia methods of marketing, offering for sale, selling and/or distributing products and services and correlating same with advertising efficacy, and methods of conducting business thereby.

### COPYRIGHT NOTICE

Copyright Notice 2005 Blue Frog Mobile, Inc. All rights reserved. A portion of the disclosure of this patent application/patent document contains material which is subject to copyright protection. The copyright owner has no objection to the facsimile reproduction by anyone of the patent document or of the patent disclosure as it appears in the U.S. Patent and Trademark Office.

### BACKGROUND OF THE INVENTION

One of the most profoundly fundamental advances in media advertising and sales of products and services has been through telephone connections which enable the Short Messaging Service (“SMS”) protocol for text messaging and its progeny the Multimedia Messaging Service (“MMS”) protocol which allow for various messages and/or advertisements in a variety of forms that are transferred or transmitted to message receivers by phone, e-mail, facsimile, and audio. A message receiver may be a laptop computer, a mobile phone device, a personal digital assistant (“PDA”) device, and a desktop computer, television or radio receiver. MMS is a particularly powerful communications technology which allows users to exchange wireless multi-media communications between enabled mobile phones and other devices virtually instantaneously, in the form of images, audio, video clips, animation, graphic representations, such as of business performance, sports and news weather reports in addition to text. Such technology may even include the transmission of streaming video in the future. Current widely used MMS applications include picture messaging from MMS-enabled camera phones for immediate delivery to mobile recipients, and other displays which are analogous to a Power Point presentation. Unlike SMS (and EMS) messages, the size of MMS messages is unlimited, with the only size restrictions likely to be imposed by service providers. MMS capable devices are currently available from a number of vendors, including, for example, Ericsson, Motorola, and Nokia.

As may be envisioned, such a powerful communications tools may be employed in various methods to maximize the marketing and sales potential of many and varied services and goods, as such messaging may reach a greatly expanded audience virtually anytime, and anyplace. For example, the GSM (Global System for Mobile Communications Association) has reported that over 500 billion short messages were sent by way of the GSM system as early as 2001. This number may only be presumed to be dramatically increasing as more and more message service providers are providing message facilities for the dissemination of varied messages such as financial information, stock information, and news and entertainment information.

With the development of such communication technology and widespread business applications, the opportunities to exploit new business developments and methods of conducting business with the use of such message services are unheralded.

For example, in U.S. Published Patent Application No. US2004/00932281, there is described a system and method for the remote purchasing of products and services in which as part of the transaction a purchaser indicates a specific physical location where a product will be claimed and can identify a third party as a recipient by providing the third party's e-mail or text messaging address and by also including other particulars by attaching a personalized message to the transaction, such as multimedia files including photos and audio recordings for expedited purchases.

In U.S. Published Patent Application No. 2002/0049644, there is disclosed a system for the execution of commercial transactions from a wired or wireless customer device, in which a transaction code is transmitted by the customer device to initiate the transaction. As also disclosed, a customer device can be automatically populated with transaction codes. Here, coded information for the automatic execution of a commercial transaction is generated by a vendor. The transaction code is then electronically conveyed to the customer's device, for example, by text messaging or infrared communications, and then downloaded and automatically stored within the customer's device to avoid future potentially cumbersome maneuvers of manually entering a transaction code by the customer. Transaction codes can thereafter be transmitted by the customer's device to initiate the execution of an associated commercial transaction with minimal effort on the part of the customer.

There exist still greater potential to maximize marketing and sales information via the current explosion in communication technologies.

### SUMMARY OF THE INVENTION

In accordance with that above, the present invention covers a method, system and method for conducting business comprising the generation and implementation of specific data sets that allow a vendor company, or any other entity, to automatically track sales related to advertisements in a variety of venues, virtually in real time, such as in publications, the Internet, magazines, newspapers, news letters, television, radio and other media types, as well as direct marketing through SMS, EMS and MMS messaging. The inventive method and system further provides for the establishment of multimedia media messaging centers for providing recipients with as many text and multimedia messages and related advertising feedback as possible regardless of the terminal type used, and for the highly accurate and efficient tracking of advertisements resulting in sales of specific goods and services.

The invention is more fully understood with reference to the following Detailed Discussion of Preferred Embodiments with accompanying drawings.

### BRIEF DISCUSSION OF THE DRAWINGS

FIG. 1 is an illustrated schematic diagram of a mobile phone device goods and/or services for purchase method and system in accordance with present invention.

FIG. 2 illustrates by schematic diagram another embodiment of the mobile phone device goods and/or services for purchase method and system in accordance with present invention.

FIG. 3 illustrates by schematic diagram another embodiment of a mobile phone device goods and/or services for purchase method and system in accordance with present invention.

FIG. 4 illustrates by schematic diagram another embodiment of the present invention.

FIG. 5 illustrates by schematic diagram another embodiment of the present invention.

FIG. 6 illustrates by schematic diagram another embodiment of the present invention.

FIG. 7 illustrates by schematic diagram another embodiment of the present invention.

FIG. 8 illustrates by schematic diagram another embodiment of the present invention.

### DETAILED DISCUSSION OF PREFERRED EMBODIMENTS

All patents references, published patent applications in literature references referred to a cited herein are expressly incorporated by reference. Any inconsistency between these publications and the present disclosure is intended to and will be resolved in favor of the present disclosure.

In the following discussion, many specific details are provided to set forth a thorough understanding of the present invention. It will be obvious, however, to those skilled in the art that the present invention may be practiced without specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some preferred embodiments, the functions are performed by a processor such as a computer or electronic data processor in accordance with code, such as computer program code, software, and/or integrated circuits that are coded to perform such functions.

Having thus practiced this discussion, the present invention provides a new and unique method, system and methods for conducting business which comprises the generation and implementation of specific data sets that allow a vendor company, or other entity, to track or otherwise correlate sales of goods and/or services related to advertisements therefor in various publications, the Internet and/or other media venues, as well as direct marketing through SMS, EMS, and MMS messaging. The present inventive method and system contemplates the operation and collection of such advertisement correlation data, in some preferred embodiments, through the establishment of multimedia messaging capability for providing recipients with as many multimedia messages as possible with related advertisement feedback regardless of the terminal type employed, for generation of highly accurate and efficient tracking of advertisement efficacy resulting in sales of specific goods and services.

One of the several ways for a business endeavor to achieve success is through the tracking of dedicated advertising capital investments and the recovery of related purchase and sales information. Such information providing for correlation with advertising efficacy is oftentimes crucial and provides a distinct business advantage in the allocation of operating capital. To this end, the inventive method and system enables the capability of tracking sales to specific advertisements, in some embodiments in virtually real time, and if desired to specific advertising particulars, to ensure that an entity is offering and attempting to sell or vend subject matter in the right place, venue or medium for maximizing the exploitation of available advertising capital.

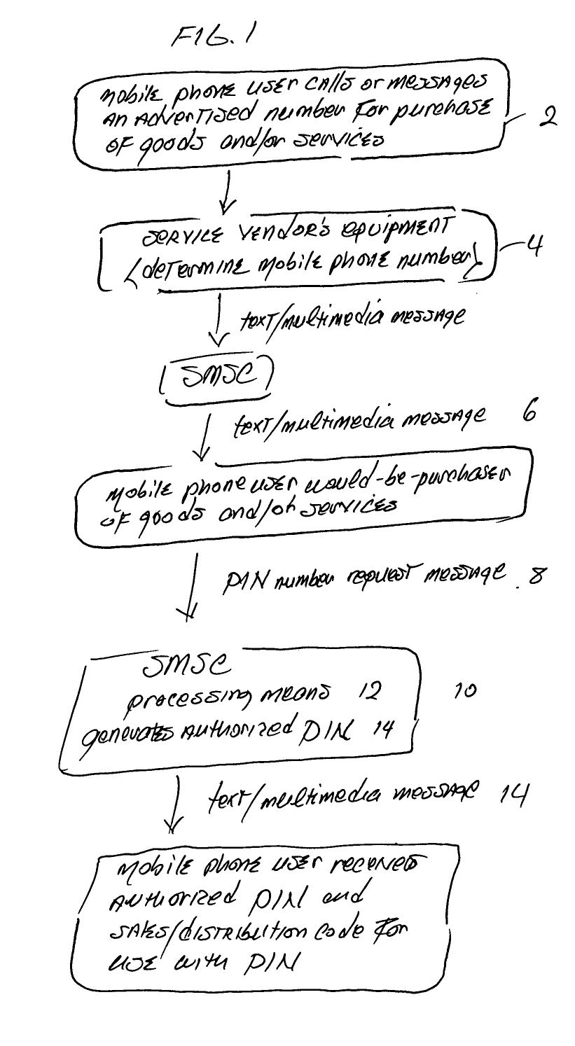

Referring now to FIG. 1, there is illustrated in a general schematic flow diagram one embodiment of the inventive method and system with various optional components and features for monitoring purchase orders for goods and/or services for correlation with various advertising activities. It will be appreciated by those skilled in the art that this model is highly flexible and may be altered to fit in with any desired or contemplatred scheme or business plan without departing from the scope or spirit of the invention. In FIG. 1 a mobile phone device, for example a cell phone, user and would-be purchaser (2) places a call to a number which is one advertised or made available for purchase of various services and/or goods. The user may also send a text or multimedia message to an advertised number, with the terms “caller” and “call” being meant to include text and/or multimedia messaging herein. The call is received by a service vendor's equipment (4), and the caller's mobile telephone number determined. Next, the caller would-be purchaser is forwarded an SMS text message (or perhaps an animated MMS message and the like) (6) which can take any of several forms. For example, in one embodiment the caller may be sent a specific text message which offers a way to bill the cost or fee of the desired purchased services or goods to their cell phone service. In another embodiment, the caller may be offered via an SMS text message routed to their cell phone number a menu choice number for the cell phone user to actuate with instructional prompt as to fee payment methods. After receiving specific use instructions from any of such embodiments, as, for example, prompted on the vendor's configured platform, the cell phone caller can then send a PIN number request message (8) which is received and processed by a Short Message Service Center (SMSC) (10). Next, the SMSC (10), after receipt and processing of the request message (8), through, for example, automated means or preconfigured platform (12), forwards to the cell phone user an SMS/MMS message containing an authorized PIN code (14), or perhaps one of several SMS/MMS text/multimedia messages, such as instructional and/or warranty or terms of use messages in concatenated form in conjunction with an authorization PIN code. This message will also contain a sales code or distribution code and the like which identifies the goods and/or services being sold, and preferably identifies the mode and place of advertisement(s) prompting the sale of goods and/or services, and may optionally be configured to indicate the date and time of sale consummation and the number of times referred to by an individual purchaser. An example message or exchange may be the following sequence:
i) “Thank you for your interest in or service (or products)”
ii) “Remember, your PIN code is good for only XXX minutes worth of access to our service and is good for a period of XXX hours.”
iii) “Here is your PIN code, XXX. Please call the number you originally called and enter your PIN code as requested. Please also enter the following sequence code: XXXXXZZZ#@**% which follows the number (which in code identifies the goods and/or services purchased, the time of day, the date, a specific advertisement referred to and its location).
   Please allow for X minutes for activation.”

An ATM may then communicate the activated PIN code to the vendor's operation for verification purposes, for example, through a dedicated IP address, along with coded purchase information indicating the type and venue of advertisement correlated to the instant purchase of services and/or goods. Upon receipt, the vendor can then store the activated PIN code for data base retrieval, read and verification for, say, a period of XX hours. After the purchased prescribed time period has elapsed the vendor can then delete the PIN code, for example, by lapse automatic means, from an approved list for reissue and reactivation in future timed service and/or goods purchases, and the coded advertising correlation data may be stored in a data base indicating efficacy of sales, for example, per hour, day, week and the like. Such may optionally be broken down by coded requests for age, gender, race, demographics, purchase habits and the like.

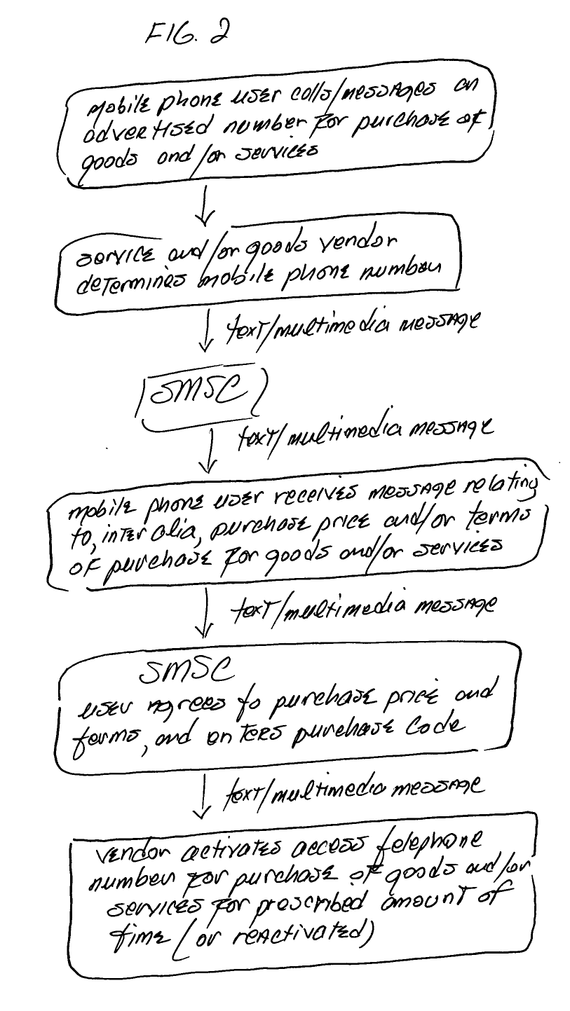

In another example, as shown in the flow schematic of FIG. 2, where a PIN code is not employed or required, upon receiving an SMS message(s) in response to a call from an advertised number and agreeing to terms, such as billing charges and the like in addition to entering a purchase code correlating advertising data with purchase information, such as described above, a telephone number for the receipt of services (or goods as desired) will be activated by the inventive method and system for a prescribed amount of time, and perhaps reactivated for additional prescribed amounts of time as the case may be, optionally by indicating purchase code/advertising correlation data each time, such as by described above.

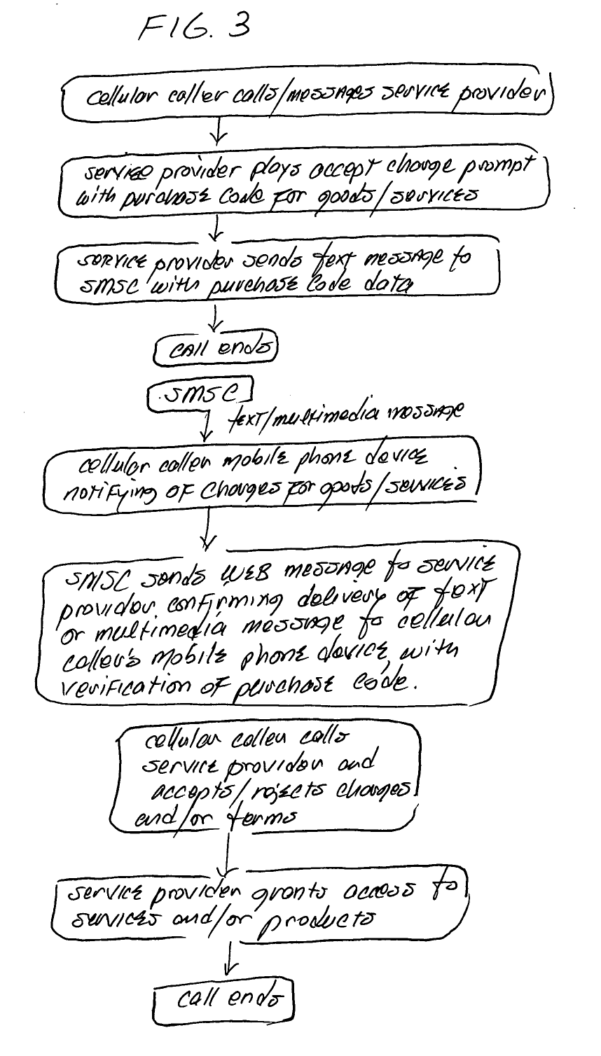

In another example shown in FIG. 3 in accordance with the invention, a cellular caller calls a service provider with the contemplated purchase of goods and/or services by way of an advertised number. The service provider in response plays an automated accept prompt to the cellular caller, which may also contain a purchase code for such goods and/or services for the cellular caller to enter in relation to a particular advertisement and number called. The service provider then sends an SMS message to an SMS Service Center (SMSC) with the purchase coded/advertisement correlation data and the call ends. Next, the SMSC sends an SMS/MMS message to the mobile phone device of the cellular caller notifying same of the charges for the goods and/or services, and also sends a Web message to the service provider confirming the delivery of the SMS/MMS message to the caller's mobile phone device, optionally with verification of purchase code provided. The caller then calls the service provider and, depending upon, for example, whether charges were accepted, the service provider grants the caller access to services and/or products, and optionally verifies the purchase code/advertisement correlation data.

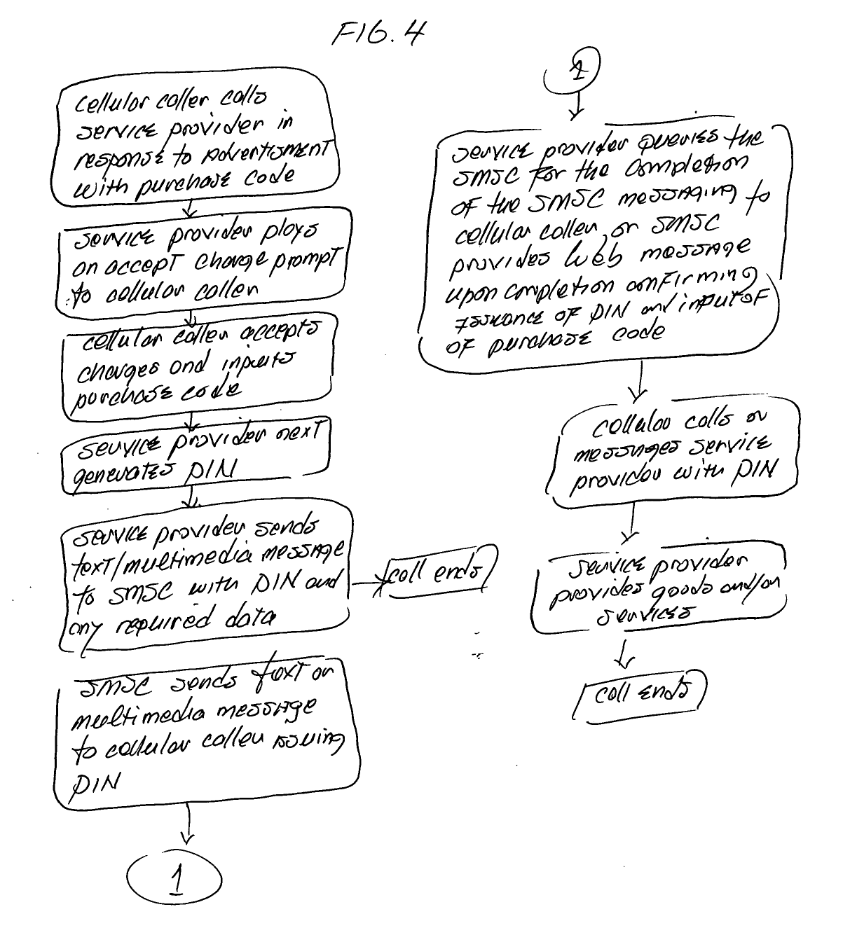

In FIG. 4 another exemplified embodiment of the invention is provided, in which a cellular caller calls the service provider with the contemplated purchase of goods and/or services in response to a particular advertisement which is provided with an identification or purchase code and optionally a time and date of use code. In response, the service provider plays an accept charge prompt to the cellular caller who accepts the charges and the prompt's request to input a purchase code which is indicative of the advertisement viewed by the caller, the time viewed, date and the like. The service provider then generates a PIN number for access to goods and services and sends an SMS message to an SMSC with the generated PIN number and any and all other required data. The SMSC next sends an SMS/MMS message to the cellular caller in which the PIN number is issued to the caller. Optionally, the service provider make query the SMSC for completion of the SMSC messaging to the mobile phone device of the cellular caller and in the input of purchase code/advertisement correlation data, or the SMSC may provide a web message to the service provider confirming the SMS message to the cellular caller, the issuance of the PIN number and the input of purchase code/advertisement correlation data. The cellular caller may then call the service provider and provide the issued PIN number for access to goods and/or services as desired or contemplated.

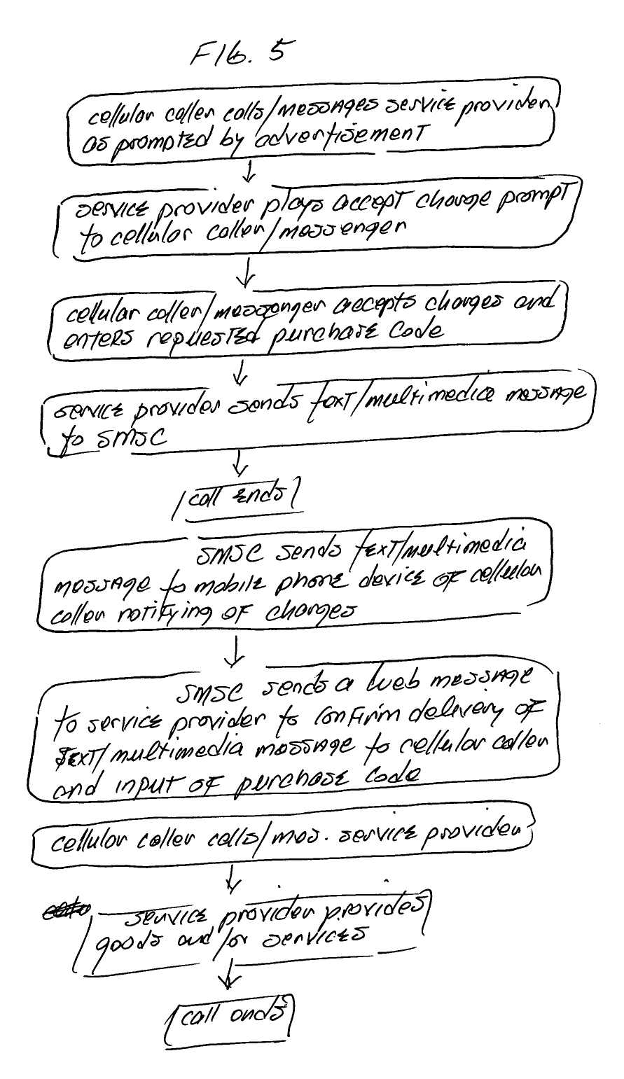

Turning next to FIG. 5, an additional embodiment of the invention is schematically portrayed in a flow diagram in which a cellular caller would-be purchaser, first calls a service provider as prompted by an advertisement with provided telephone numbers, and in response the service provider plays an accept charge prompt to the cellular caller who either accepts and enters a requested purchase code/correlation advertisement data code or does not accept the proposed charges and the terms of purchase for contemplated goods and/or services. Upon acceptance, however, the service provider sends an SMS message to the SMSC, which sends an SMS/MMS message to the mobile phone device of the cellular caller notifying the caller of the charges. Optionally, the SMSC can send a Web message to the service provider to confirm the delivery of the SMS/MMS message to the mobile phone device of the caller and the input of purchase code/advertisement correlation data. The cellular caller may then call or message the service provider to gain access to contemplated goods and/or services.

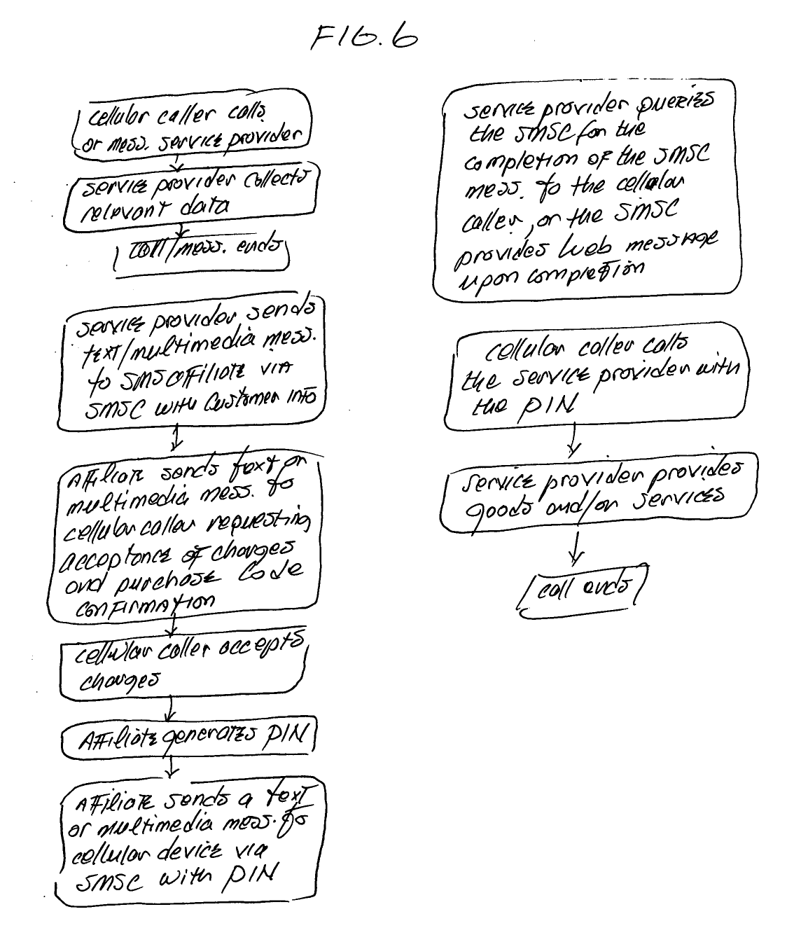

In the schematically portrayed embodiment of FIG. 6, a cellular caller would-be purchaser calls a service provider as advertised with the contemplated purchase of goods and/or services, and in response the service provider obtains from the caller relevant and/or requested information, such as identification, electronic purchase information, and identifies purchase code/advertisement correlation data provided on the advertisement. The service provider then sends an SMS message to an SMS affiliate via an SMSC with the cellular customer information provided. The affiliate sends an SMS/MMS message to the mobile phone device of the cellular caller requesting acceptance of proposed charges and/or purchase terms, and optionally confirmation of the purchase code/advertisement correlation data. Upon acceptance of same by the caller the affiliate generates a PIN number for purchase or access of the caller to contemplated goods and/or services, and sends an SMS/MMS message to the mobile phone device of the cellular caller via an SMSC presenting the PIN number. Optionally, the service provider may query the SMSC for completion of the SMSC messaging to the mobile phone device of the cellular caller, or a web message may be provided to the service provider by the SMSC upon completion. The cellular caller then calls the service provider and presents the issued PIN number for access to contemplated goods and/or services.

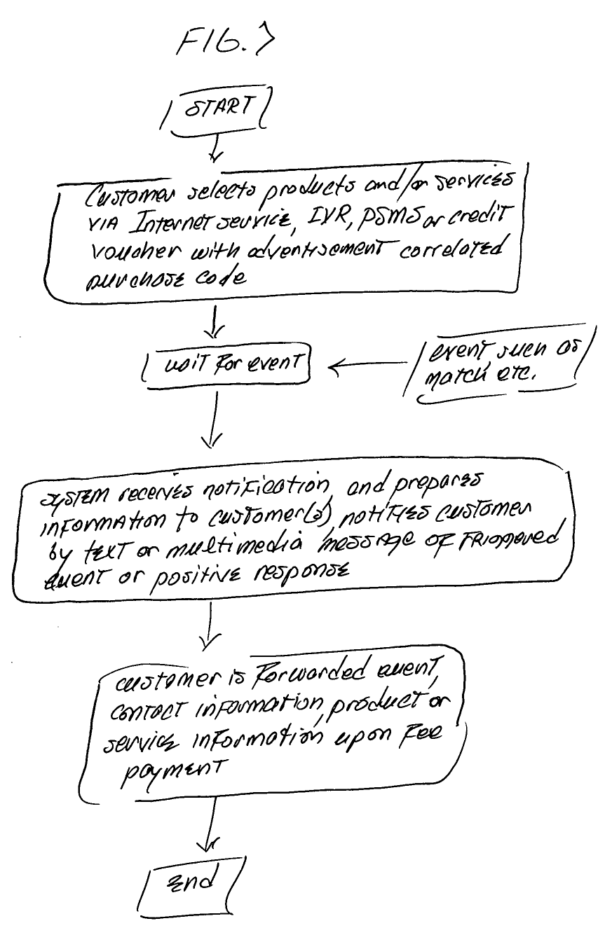

Referring now to FIG. 7, there is illustrated in schematic flow chart form an additional preferred embodiment of the invention. In this example a customer first selects by way of an advertisement a service or product through an Internet-based service, IVR, PSMS or credit voucher, along with product purchase code correlated to the advertisement viewed, and the selection data is stored. A triggering event with respect to, or otherwise responsive to, the initial request is then waited for to occur, such as a positive personal dating match inquiry or the notification of the availability of a certain product, collectible and the like. Upon notification of a data collection system or other receiver method or system, such as an inquiry processing center, the inquiry is collected, processed and prepared for dissemination to the customer submitting the initial request, who is first forwarded an SMS/MMS message that the person has received a positive response, such as an interested personal connection, or that a certain rare collectible is available for a certain price or terms. The SMS/MMS message may also state that more information, such as contact information and the like, will be provided by a selected means as agreed and advised of a fee payment schedule or options to receive and to continue to receive such services.

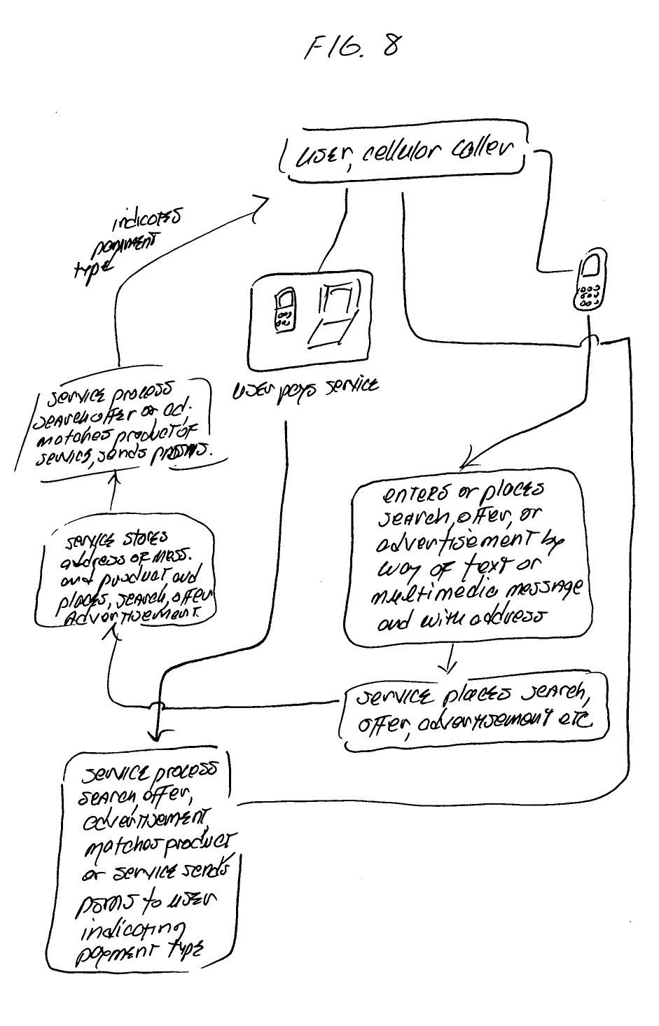

In FIG. 8, there is illustrated yet another customer purchase transaction embodiment in accordance with the invention by way of a flow chart schematic. Here, a customer by way of, for example, a mobile phone device places or enters a search or offer, or other advertisement, in an SMS/MMS message, or on the Internet at a web site or through e-mail and the like with a service provider. The service provider advertisement or web site will contain a purchase code or otherwise a use code. The service provider stores the address of the customer and other contact information and the contents of the message, and then places the search, offer or advertisement in a publicly accessible medium, such as a web site, magazine or e-mail. Upon a triggering event, such as a positive response to the advertisement from another interested person or persons who are prompted to input an advertisement code in their response, the service provider contacts the customer by an SMS message with the news of such positive response and also indicates a fee payment to receive further information with respect to positive responders by which a connection of some sort may be consummated. A fee payment request may also be made by the service provider to the customer while initially placing advertisement. The customer then pays the service as agreed, and the service provider sends via an SMS message contact information and the like, and if agreed to, for example, upon additional fee payment the service provider will continue to contact the customer with news of additional positive responses to the advertisement, all of which responses are correlated with the input of an advertisement code as requested with which to monitor the efficacy of the advertisement.

In yet another aspect of the invention, as an illustrated example for use with such above-described embodiments, a service provider may place an advertisement in a magazine, or other public medium, which may offer any service and/or product, such as a dating service and the like, which may state:
Send an SMS text message to the provided number if you want to date or find a friend or chat or find that special someone or perhaps locate that vintage auto you have been looking for. Our fee is only 99 cents for each message, or message packages may be purchased separately. Please use code ZZZ%$#888 when responding.

An interested person viewing the advertisement may decide to respond, and forward an SMS text message from a mobile phone device, for example, using the requested appropriate code as requested above, which will be logged into a database to measure the efficacy of the advertisement, such as to its venue of placement and the like for future analysis of allocation of advertising capital.

It will also be appreciated by those skilled in the arts that the present inventive method and system affords distinct business advantages not previously available to vendors relating to the telephonic sale and transfer of goods and/or services and related information. In this aspect the present invention provides novel methods of conducting an array of business functions comprising, without limitation, marketing, selling, licensing and leasing the inventive subject matter, and further providing novel methods of business entity formation, such as partnerships and corporations for conducting the business of the invention.

While the invention has been described in connection with what is presently considered to be the most practical and preferred embodiments, it is to be understood that this invention is not to be limited to the disclosed embodiments in any way which are merely set forth for illustrative purposes only. To the contrary, the present inventive method system, and method for conducting business in general, is intended to cover an array of various modifications and equivalent arrangements all of which are contemplated for inclusion within the spirit and scope of the disclosure and appended claims.

We claim:

1. A method for purchase of goods and/or service comprising the steps of,
(a) a caller or would-be-purchaser calling a service provider or vendor from a mobile phone device by way of an advertised number;
(b) the caller ordering and/or purchasing goods and/or services while indicating a purchase code for said goods and/or services in correlation with said advertisement.

2. The method of claim 1 wherein said purchase code indication is performed via an SMS message, and MMS message, any MS message, and e-mail, a facsimile, our telephone call.

3. The method of claim 1 wherein said services and goods are selected from the group consisting of dating services, matchmaking services, adult content services, technical support or know-how services, tutoring, language learning, educational services, professional services including legal, medical, psychiatric, psychological, marriage counseling and counseling services in general, gaming and gambling services, sports news and sports book services, business and financial services, architectural services, engineering services, automotive services, tax and accounting services, cleaning services, credit reporting services, regulatory services, whether services, stock market services, computer software and any and all at executable products, financial products, application products, designing engineering products, gaming products, products for use with cellular phones, architectural products, tolls, fines, and music and any search products, including personal histories, genealogies, criminal histories, automotive and product histories, and credit histories.

4. A system comprising the method of claim 1.

5. A system comprising the method of claim 2.

6. A system comprising the method of claim 3.

7. The method of claim I wherein said purchase code correlates with said advertisement to indicate the efficacy of the advertisement in the sale of goods and/or services.
